(19) United States
(12) Patent Application Publication
(10) Pub. No.: US 2024/0372844 A1
(43) Pub. Date: Nov. 7, 2024

(54) METHOD AND DEVICE OF DEVICE NETWORK CONFIGURATION, STORAGE MEDIUM AND ELECTRONIC DEVICE

(71) Applicant: SHENZHEN TCL NEW TECHNOLOGY CO., LTD., Shenzhen, Guangdong (CN)

(72) Inventor: Hui LI, Shenzhen, Guangdong (CN)

(21) Appl. No.: 18/292,940

(22) PCT Filed: Jun. 7, 2022
(86) PCT No.: PCT/CN2022/097469

§ 371 Date: Jan. 29, 2024

(30) Foreign Application Priority Data
Jul. 29, 2021 (CN) 202110863699.4

(51) Int. Cl. H04L 9/40

(52) U.S. Cl. CPC H04L 63/08; H04L 63/12

(57) ABSTRACT

The present application discloses a method and an apparatus of device network configuration, a storage medium, and an electronic device and relates to a technical field of the Internet of Things. The method includes: receiving device description information including device configuration information and flow information; performing an authentication flow indicated by the flow information and obtaining signature information; transmitting the signature information to the target device to perform network configuration processing on the target device. The present application effectively improves reliability of network configuration of an Internet of Thing devices.

### TECHNICAL FIELD

The present disclosure relates to a technical field of the Internet of Things, and more particularly, to a method and an apparatus of device network configuration, a storage medium, and an electronic device.

### BACKGROUND

Interconnection and interworking of devices in the field of the Internet of Things has become a trend in the future. The interconnection and interworking of devices is realized through a device network configuration. However, the current progress is not going well, because merely a main control device is usually bonded in the device network configuration.

In this way, it is difficult to authenticate the identity of the main control device, so as to ensure the security of the data. After a device is bound by the main control device, the user's usage habit cannot be obtained to improve the product, so that the device manufacturer resists interconnection and interworking of the device.

### SUMMARY

### Technical Problem

Therefore, the current way of device network configuration suffers from poor network configuration reliability and poor user experience.

### Technical Solutions for Problem

### Technical Solution

The present disclosure provides a solution that may effectively improve reliability of the network configuration of an Internet of Things device.

To solve the above technical problems, the embodiments of the present disclosure provide the following technical solutions:

In an embodiment of the present disclosure, a device network configuration method applied to a main control device includes: receiving device description information transmitted by a target device, and the device description information includes device configuration information and flow information; performing an authentication flow indicated by the flow information based on the device configuration information and obtaining signature information generated by a management server of the target device in response that authentication of the main control device by the management server passes; and transmitting the signature information to the target device to perform network configuration processing on the target device after the signature information is validated by the target device.

In an embodiment of the present disclosure, the performing of the authentication flow indicated by the flow information based on the device configuration information and the obtaining of the signature information generated by the management server of the target device in response that the authentication of the main control device by the management server passes includes: querying device management information of the target device from a common server based on the device configuration information; and performing an authentication operation corresponding to the device management information and obtaining the signature information generated by the management server of the target device in response that the authentication of the main control device by the management server passes

In an embodiment of the present disclosure, the device management information includes a target network address, and the performing of the authentication operation corresponding to the device management information and the obtaining of the signature information generated by the management server of the target device in response that the authentication of the main control device by the management server passes includes: performing the authentication operation based on the target network address so that the management server performs an authenticate operation on the main control device and generates the signature information in response that the authentication passes; and receiving the signature information returned by the management server.

In an embodiment of the present disclosure, the performing of the authentication operation based on the target network address so that the management server performs the authenticate operation on the main control device and generates the signature information in response that the authentication passes includes: performing the authentication operation based on the target network address, so as to perform bidirectional authentication of a hyper text transfer protocol over secure socket layer with the management server and so as to trigger the management server to authenticate the main control device and to generate the signature information in response that the authentication passes.

In an embodiment of the present disclosure, the performing of the bidirectional authentication of the hyper text transfer protocol over secure socket layer with the management server includes: performing the bidirectional authentication of the hyper text transfer protocol over secure socket layer with the management server based on a device certificate of the main control device, wherein a validity period of the device certificate is less than a preset threshold value, and the device certificate is generated by an ecological server of the main control device.

In an embodiment of the present disclosure, the performing of the authentication operation based on the target network address so that the management server performs an authenticate operation on the main control device and generates the signature information in response that the authentication passes includes: performing the authentication operation based on the target network address, so as to transmit management account information of the target device to the management server, and so as to trigger the management server to authenticate the main control device based on the management account information and to generate the signature information in response that the authentication passes.

In an embodiment of the present disclosure, the performing of the authentication operation based on the target network address includes: enabling a target application program based on the target network address; and performing the authentication operation based on the target application program.

In an embodiment of the present disclosure, the device configuration information includes a device manufacturer identification and a device model of the target device, the querying of the device management information of the target device from the common server based on the device configuration information includes: querying the device management information uploaded by a device manufacturer of the target device from the common server based on the device manufacturer identification and the device model of the target device.

In an embodiment of the present disclosure, a device network configuration method applied to a management server for managing a target device and including: receiving authentication information uploaded by a main control device; generating signature information in response that authentication of the main control device passes based on the authentication information; and transmitting the signature information to the target device through the main control device to perform network configuration processing on the target device by the main control device after the signature information is verified by the target device.

In an embodiment of the present disclosure, the generating of the signature information includes: generating random signature information as the signature information.

In an embodiment of the present disclosure, the authentication information includes management account information of the target device; the generating of the random signature information as the signature information includes: storing the signature information and the management account information associatively.

In an embodiment of the present disclosure, the generating of the signature information includes: receiving device configuration information of the target device uploaded by the main control device; and generating the signature information based on the authentication information and the device configuration information.

In an embodiment of the present disclosure, the authentication information includes an authentication parameter used when the main control device performs bidirectional authentication of a hyper text transfer protocol over secure socket layer with the management server; the generating of the signature information based on the authentication information and the device configuration information includes: performing signature processing on the authentication parameter and the device configuration information based on a target signature algorithm to generate the signature information.

In an embodiment of the present disclosure, a device network configuration method applied to a target device includes: transmitting device description information including device configuration information and flow information to a main control device, so that the main control device performs an authentication flow indicated by the flow information based on the device configuration information and obtains signature information generated by a management server of the target device in response that authentication of the main control device by the management server passes; receiving the signature information transmitted by the main control device; and verifying the signature information so that network configuration processing is performed on the target device by the main control device after the signature information is verified.

In an embodiment of the present disclosure, the verifying of the signature information includes: validating the signature information through the management server.

In an embodiment of the present disclosure, the signature information is generated based on a target signature algorithm, and the verifying of the signature information includes: verifying the signature information based on the target signature algorithm.

In an embodiment of the present disclosure, the verifying of the signature information so that the network configuration processing is performed on the target device by the main control device after the signature information is verified includes: obtaining a network configuration parameter transmitted by the main control device; and verifying the signature information, to perform the network configuration processing on the target device based on the network configuration parameter after verifying the signature information.

In an embodiment of the present disclosure, a device network configuration apparatus applied to a main control device includes: a device description information receiving module configured to receive device description information transmitted by a target device, wherein the device description information includes device configuration information and flow information; an authentication application module configured to perform an authentication flow indicated by the flow information based on the device configuration information, and obtain signature information generated by a management server of the target device in response that authentication of the main control device by the management server passes; and a network configuration module configured to transmit the signature information to the target device to perform network configuration processing on the target device after the signature information is validated by the target device.

In an embodiment of the present disclosure, a device network configuration method applied to a management server for managing a target device includes: an authentication information receiving module configured to receive the authentication information uploaded by a main control device; an authentication response module configured to generate the signature information in response that authentication of the main control device passes based on the authentication information; and a signature information issuing module configured to transmit the signature information to the target device through the main control device so that the network configuration processing is performed on the target device by the main control device after the signature information is verified by the target device.

In an embodiment of the present disclosure, a device network configuration apparatus applied to a target device includes: a device description information transmitting module configured to transmit device description information including device configuration information and flow information to a main control device, so that the main control device performs an authentication flow indicated by the flow information based on the device configuration information and obtains signature information generated by a management server of the target device in response that authentication of the main control device by the management server passes; a signature information receiving module configured to receive the signature information transmitted by the main control device; a signature information validation module configured to verify the signature information so that network configuration processing is performed on the target device by the main control device after the signature information is verified

In another embodiment of the present disclosure, a computer-readable storage medium having stored thereon a computer program which, when executed by a processor of a computer, configured for the computer to perform operations of the method according to any of embodiments of the present disclosure.

In another embodiment of the present disclosure, an electronic device may include a memory storing a computer program; a processor for reading a computer program stored in the memory to perform operations of the method according to any of embodiments of the present disclosure.

### Beneficial Effect of the Invention

### Beneficial Effect

In an embodiment of the present disclosure, the main control device may receive device description information, transmitted by a target device, including device configuration information and flow information; performing an authentication flow indicated by the flow information based on the device configuration information and obtaining signature information generated by a management server of the target device in response that authentication of the main control device by the management server passes; and transmitting the signature information to the target device to perform network configuration processing on the target device after the signature information is validated by the target device.

In this way, based on the network configuration of the main control device, the main control device may execute the user-defined authentication flow through the device configuration information in the network configuration phase, so that the management server of the target device authenticates the main control device, and so that the authentication of the security of the main control device is realized when the network configuration is executed on the target device. Meanwhile, the management server is reliably associated with the ecology of the main control device through the authentication flow. The management server may obtain the use data of the device in the later stage. The reliability of the overall network configuration process is effectively improved.

### BRIEF DESCRIPTION OF THE DRAWINGS

### Drawing Illustration

In order to more clearly illustrate technical solutions in embodiments of the present disclosure, the accompanying drawings depicted in the description of the embodiments will be briefly described below. It will be apparent that the accompanying drawings in the following description are merely some embodiments of the present disclosure, and other drawings may be obtained from these drawings without creative effort by those skilled in the art.

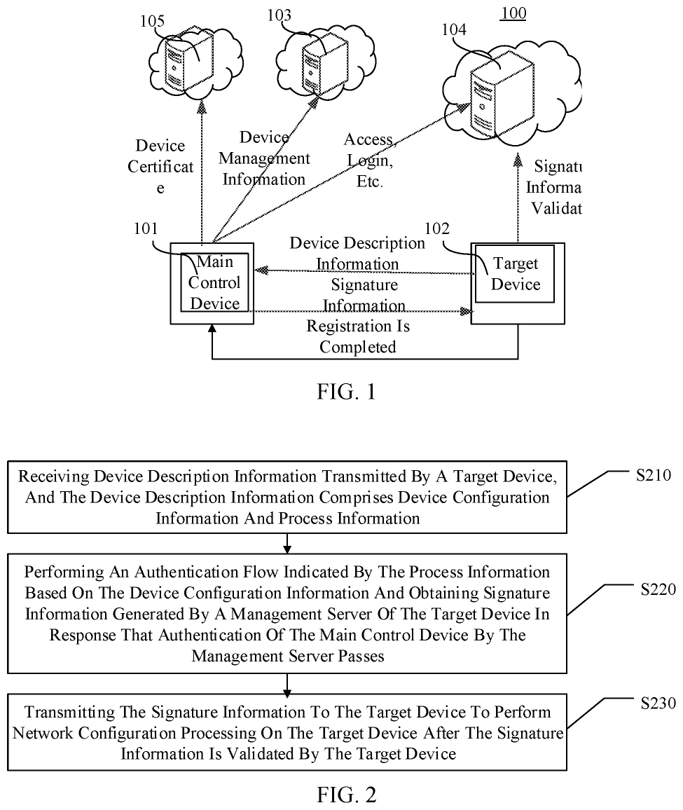

FIG. 1 shows a schematic diagram of a system according to an embodiment of the present disclosure.

FIG. 2 shows a flowchart of a device network configuration method according to an embodiment of the present disclosure.

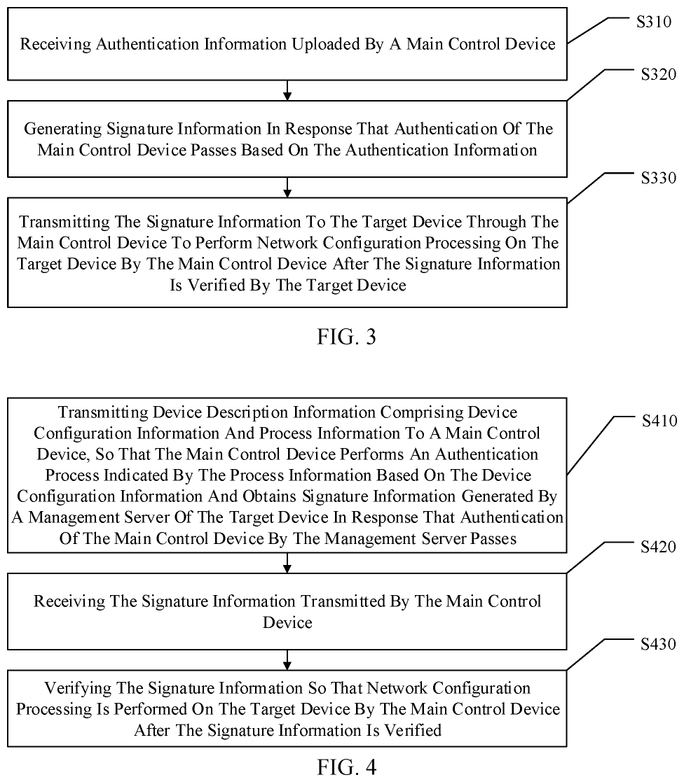

FIG. 3 shows a flowchart of a device network configuration method according to another embodiment of the present disclosure.

FIG. 4 shows a flowchart of a device network configuration method according to another embodiment of the present disclosure.

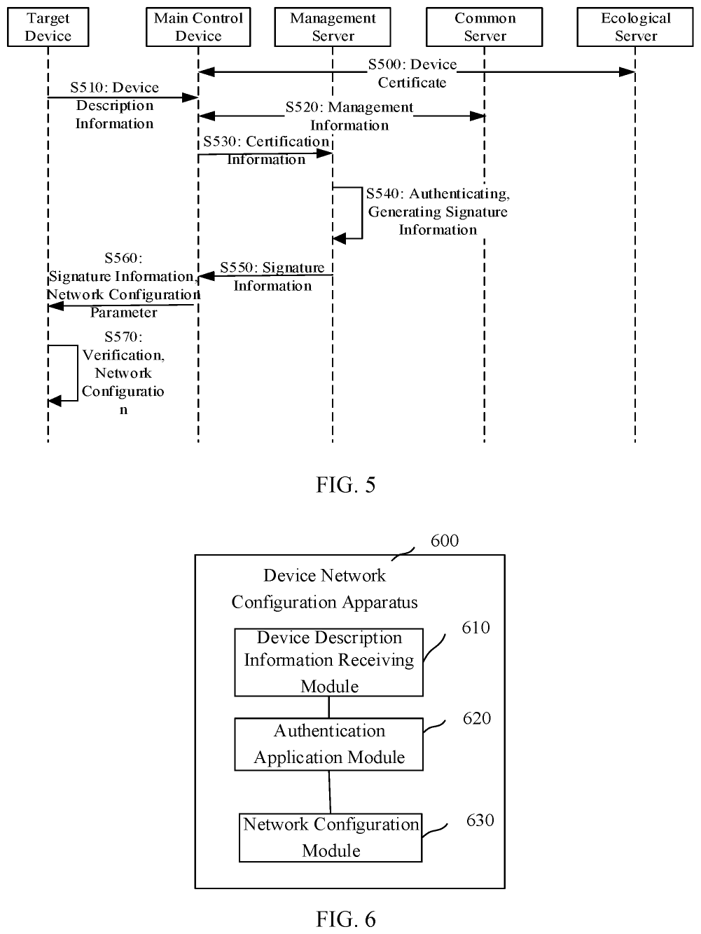

FIG. 5 shows a flowchart of multi-terminal interaction when a device network configuration method according to an embodiment of the present disclosure is applied in the scenario.

FIG. 6 shows a block diagram of a device network configuration apparatus according to an embodiment of the present disclosure.

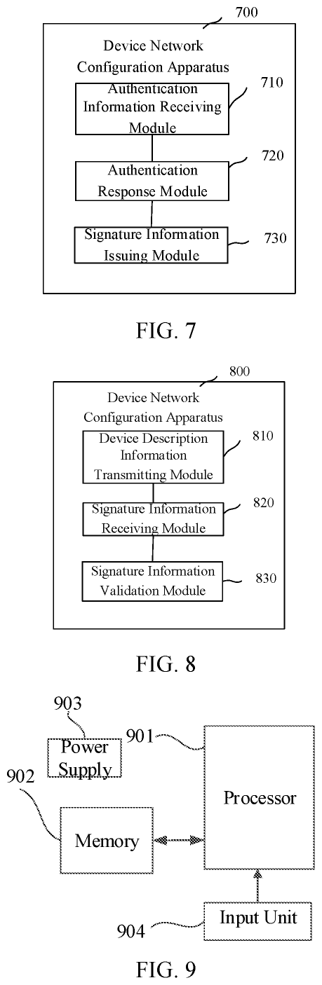

FIG. 7 shows a block diagram of a device network configuration apparatus according to an embodiment of the present disclosure.

FIG. 8 shows a block diagram of a device network configuration apparatus according to an embodiment of the present disclosure.

FIG. 9 shows a block diagram of an electronic device according to an embodiment of the present disclosure.

### EMBODIMENTS OF THE INVENTION

### DETAILED DESCRIPTION

Technical solutions in embodiments of the present disclosure will be clearly and completely described below in conjunction with drawings in the embodiments of the present disclosure. Apparently, the described embodiments are only a part of embodiments of the present disclosure, rather than all the embodiments. According to the embodiments of the present disclosure, all other embodiments obtained by those skilled in the art without creative work fall within the scope of the present disclosure.

In the following description, specific embodiments of the present disclosure will be described with reference to the steps and symbols executed by one or more computers, unless otherwise indicated. Accordingly, these steps and operations will be referred to several times as being executed by a computer, and the computer referred to herein performs an operation of a computer processing unit including electronic signals representing data in a structured version. This operation converts the data or maintains it at a location in a memory system of the computer, which may be reconfigured or otherwise alter the operation of the computer in a manner well known to those skilled in the art. The data structure maintained by the data is the physical location of the memory, which has specific characteristics defined by the data format. However, while the principles of the present disclosure have been described above, they are not intended to be limiting, and those skilled in the art will appreciate that the various steps and operations described below may also be implemented in hardware.

FIG. 1 shows a schematic diagram of a system 100 according to an embodiment of the present disclosure. As shown in FIG. 1, the system 100 may include a main control device 101, a target device 102, a common server 103, a management server 104, and an ecological server 105.

The main control device 101 may be any computer device, such as a computer, a mobile phone, a smart watch, a home appliance device (such as a smart speaker or the like), or the like.

The target device 102 may be any device, such as a home appliance, an in-vehicle device, or the like.

The common server 103 may be a database storing common product information (such as device management information of the target device, the device management information may include a target network address (URL)). The common server 103 may be designated and maintained by an interconnection and interworking technical scheme, an organization, such as OLA, etc. The common server 103 may be a database of cloud services, providing a common interface (API) for access by the main control device 101 and the like. The main control device 101 may query the device management information corresponding to the target device 102 from the common server 103. The device management information in the common server 103 may be maintained and signed by the device manufacturer corresponding to the target device.

The management server 104, which may also be referred to as a device server, is used as a server for managing a target device. The management server 104 may be a separate physical server, a server cluster, a cloud server, or the like. In an embodiment of the present disclosure, the management server 104 is a cloud server.

The ecological server 105 corresponds to an ecology of the main control device 101. The ecological server 105 may be a separate physical server, a server cluster, a cloud server, or the like. In an embodiment of the present disclosure, the ecological server 105 is a cloud server, which may also be referred to as an ecological cloud. The ecological server 105 may update a device certificate of the main control device 101.

In an embodiment of the present disclosure, the main control device 101 may configured to: receive device description information transmitted by the target device 102, the device description information including device configuration information and flow information; perform an authentication flow indicated by the flow information in accordance with the device configuration information, and obtain signature information (which may also be referred to as a device registration token (RegistToken)) generated by the management server 104 of the target device when the authentication of the main control device 101 by the management server 104 passes; and transmit the signature information to the target device 102 for network configuration processing after the signature information is verified by the target device 102.

In an embodiment of the present disclosure, the management server 104 may be configured to: receive authentication information uploaded by the main control device 101; generate the signature information when the authentication of the main control device 101 passes based on the authentication information; and transmit the signature information to the target device 102 through the main control device 101 so that the network configuration processing is executed by the main control device 101 after the signature information is verified by the target device 102.

In an embodiment of the present disclosure, the target device 102 may be configured to: transmit the device description information including the device configuration information and the flow information to the main control device 101, so that the main control device 101 executes the authentication flow indicated by the flow information according to the device configuration information to obtains the signature information generated by the management server 104 of the target device 102 when he authentication of the main control device 101 by the management server 104 passes; receive the signature information transmitted by the main control device 101; and verifying the signature information. The main control device 101 performs network configuration processing on the target device 102 after the signature information is verified.

FIG. 2 schematically illustrates a process diagram of a device network configuration method according to an embodiment of the present disclosure. The execution body of the device network configuration method may be a main control device, such as the main control device 101 shown in FIG. 1.

As shown in FIG. 2, the device network configuration method may include steps S210 to S230.

At Step S210, the device description information transmitted by the target device is received, where the device description information includes device configuration information and flow information. At Step S220, the authentication flow indicated by the flow information is executed in accordance with the device configuration information, and the signature information is obtained when the authentication of the main control device by the management server of the target device passes. At Step S230, the signature information is transmitted to the target device to perform the network configuration processing on the target device after the signature information is validated (or checked) by the target device.

A specific process of performing respective steps in the device network configuration is described below.

At Step S210, device description information transmitted by the target device is received, and the device description information includes the device configuration information and the flow information.

In an embodiment of this example, the device description information transmitted by the target device is information of the target device itself. In this example, the device description information may include at least device configuration information and flow information, and the device configuration information is configuration information of the target device.

The device configuration information may include a device vendor identifier of the target device (i.e., a unique identifier (VendorId) of the device vendor), a device model (i.e., a unique identifier (ProductId) of the device model), a device identifier (i.e., a short unique identifier (VendorId) of the device), and a random number generated by the device.

Here, the short unique identifier of the device is the identifier whose length is less than a predetermined threshold value, may uniquely identify the target device within a small range (for example, within the space in which the device network configuration is executed), but it is not necessary to ensure uniqueness within a large range. The use of the short unique identifier of the device may ensure efficient broadcasting of data in a case where the amount of broadcast data of the target device is limited.

The flow information is used to indicate information of a user-defined flow (for example, an authentication flow) that is determined to be executed by the main control device, and the target device may set an identifier of the user-defined flow (for example, an identifier of 1 indicates that the user-defined flow is to be executed, and an identifier of 0 indicates that the user-defined flow is not be executed).

The main control device may receive the device description information broadcast by the target device. After the target device enters the network configuration mode. The method of broadcasting the device description information of the target device may include Step a, Step b, Step c and Step d. At Step a, the target device as an analog radio access line (SoftAP) broadcasts the device description information through a WiFi protocol. At Step b, the target device as a Generic Access Profile (GAP) peripheral of Bluetooth (BLE) performs broadcast device description information. At Step C, the target device enters a local area network (LAN) network (wired to guide the user to enter the WiFi password, etc. or guide the user to enter the WiFi password through the screen of the device, etc.), and performs broadcasting through an in-network multicast or broadcast protocol. At Step D, the target device as a point-to-point device (WiFi P2P device) performs broadcasting through the WiFi protocol.

At Step S220, an authentication flow indicated by the flow information is executed in accordance with the device configuration information, and obtain signature information generated by the management server of the target device when the authentication of the main control device by the management server passes.

In an embodiment of the present example, the authentication flow indicated by the flow information is a process defined by a manager such as a device manufacturer of the target device. The authentication flow is that a process in which the main control device is authenticated by the management server of the target device when the main control device performs the network configuration to the target device.

The main control device performs the authentication flow indicated by the flow information according to the device configuration information. When the authentication of the main control device by the management server of the target device passes, a signature information (which may also be referred to as a device registration token (RegistToken)) is generated, and the signature information is transmitted to the main control device.

In an embodiment, at Step S220, the performing of the authentication flow indicated by the flow information in accordance with the device configuration information, and the obtaining of the signature information when the authentication of the main control device by the management server of the target device passes, includes:
querying device management information of the target device from the common server according to the device configuration information; performing an authentication operation corresponding to the device management information, and obtaining the signature information generated by the management server of the target device when the authentication of the main control device by the management server of the target device passes.

The flow information may be a process identifier, and the process identifier is an identifier indicating an authentication flow. For example, the target device may set a user-defined flow identifier (for example, a process identifier of 1 indicates that the authentication flow is determined to be executed, and a process identifier of 0 indicates that the authentication flow is determined not to be executed). In this case, when the flow information is a predetermined identifier 1, the authentication flow is executed by default.

The common server may be a database storing common product information, such as device management information of the target device, which may include a target network address (URL). The common server may be designated and maintained by an interconnection and interworking technical scheme, an organization, such as OLA, etc.; The common server may be a database of cloud services providing a common interface (API) for access by the main control device or the like. The device management information in the common server may be maintained and signed by the device manufacturer corresponding to the target device.

When the authentication flow is executed, the main control device may query the device management information of the target device from the common server according to the device configuration information. The device management information is the management information of the target device, and the device management information may include a target network address (URL) and other parameters. The main control device may query the device management information of the target device from the common server according to a selected plurality of parameters in the device configuration information.

In an embodiment, the device configuration information includes a device manufacturer identification and a device model of the target device. The querying of the device management information of the target device from the common server according to the device configuration information includes: querying the device management information uploaded by the device manufacturer of the target device from the common server according to the device manufacturer identification and the device model of the target device. Device management information, for the target device, maintained and signed by the device manufacturer of the target device may be accurately queried based on the device manufacturer identification and the device model.

After obtaining the device management information, the main control device performs an authentication operation corresponding to the device management information, and the management server of the target device is configured to authenticate the main control device and generating the signature information when the authentication of the main control device by the management server of the target device passes. The main control device may receive the signature information returned by the management server of the target device.

In an embodiment, the device management information includes a target network address. The step of performing the authentication operation corresponding to the device management information and obtaining the signature information generated by the management server of the target device when the authentication of the main control device by the management server of the target device passes includes: performing the authentication operation according to the target network address so that the management server performs an authenticate operation on the main control device and generates the signature information after the authentication passes, and receiving the signature information returned by the management server.

The target network address (URL) may be a network address that points to the management server. The authentication operation is performed according to the network address. The authentication information or the like may be uploaded to the management server of the target device for the main control device to perform interactive authentication with the management server. Thus, the management server performs authentication with the main control device, generates the signature information when the authentication passes, and returns the signature information to the main control device.

In an embodiment, the performing of the authentication operation according to the target network address so that the management server performs an authenticate operation on the main control device and generates the signature information when the authentication passes, includes:
performing the authentication operation according to the target network address, so as to perform bidirectional authentication of a hyper text transfer protocol over secure socket layer with the management server and so as to trigger the management server to authenticate the main control device and to generate the signature information when the authentication passes.

The main control device and the management server to perform the bidirectional authentication by exchanging device certificates according to the hyper text transfer protocol over secure socket layer (HTTPS). Based on this, the management server may authenticate the validity of the identity of the main control device.

In an embodiment, the performing of the bidirectional authentication of the hypertext transmission security protocol with the management server includes: performing the bidirectional authentication of the hyper text transfer protocol over secure socket layer with the management server based on a device certificate of the main control device, where a validity period of the device certificate is less than a preset threshold value, and the device certificate is generated by the ecological server of the main control device.

The device certificate is generated by the ecological server (for example, the ecological server 103 shown in FIG. 1) of the main control device. The validity period of the device certificate is less than the preset threshold value (for example, several days or even several hours). That is, the ecological server issues the device certificate according to the predetermined time interval, so that authentication security may be further ensured.

In an embodiment, the performing of the authentication operation according to the target network address so that the management server performs an authenticate operation on the main control device and generates the signature information when the authentication passes includes:
performing the authentication operation according to the target network address so as to transmit management account information of the target device to the management server, and so as to trigger the management server to authenticate the main control device according to the management account information and to generate the signature information when the authentication passes.

The main control device may transmit the management account information of the target device to the management server by registering or logging in to the management account. The management account information may be an account of the device manufacturer. In this way, the device manufacturer may also authenticate the main control device based on its own account by the management server.

In an embodiment, the performing of the authentication operation according to the target network address so that the management server performs an authenticate operation on the main control device and generates the signature information when the authentication passes includes:
performing the authentication operation according to the target network address, so as to transmit selection information of a data privacy protocol to the management server, and so as to so as to trigger the management server to authenticate the main control device according to the selection information and to generate the signature information when the authentication passes.

The main control device may trigger a selection interface of the data privacy protocol according to the target network address, and a selection control element for agreeing or disagreeing may be included on the selection interface. By triggering the selection control element, the main control device may transmit the selection information (for example, agreed) of the data privacy protocol to the management server. The management server may further verify the selection information according to the data privacy protocol, and the authentication passes when the main control device selects to agree to the privacy protocol, thereby generating the signature information, so that the management server may further legally collect the usage data of the target device when the main control device is bound to the target device.

In an embodiment, the performing of the authentication operation according to the target network address includes: enabling a target application program according to the target network address; performing the authentication operation based on the target application program.

In an example, the target application program may be a device manufacturer App, an applet, a fast application, or the like. If the device manufacturer App, the applet, and the fast application are installed in the main control device (such as a mobile phone), the target application program may jump to an application corresponding to the target network address by the target network address. In an example, the target application may be a browser application, and a page corresponding to the target network address may be opened in the browser application. In an example, the target application may be a device application associated with the main control device. If the main control device is a non-screen device, such as an intelligent sound box, the device application associated with the main control device may be turned on. Further, the authentication operation may be performed automatically or manually based on the target application program.

When the target application program is enabled, other parameters in the device configuration information and the device management information may be attached thereto, and the authentication operation may be efficiently executed based on the attached parameters.

At Step S230, the signature information is transmitted to the target device to perform the network configuration processing on the target device after the signature information is validated by the target device.

After the main control device obtains the signature information, the main control device transmits the signature information to the target device, and the target device may validate whether the authentication of the main control device by the management server passes based on the signature information. Then, after the target device validates the signature information, the main control device is allowed to perform network configuration processing on the target device, so that the authentication of the security of the main control device is realized when the network configuration is executed on the target device. Meanwhile, the management server is reliably associated with the ecology of the main control device through the authentication flow. The management server may obtain the use data of the device in the later stage. The reliability of the overall network configuration process is effectively improved, and the user experience is improved.

In the network configuration process, the authentication flow is performed by the device configuration information, so that at least the identity authentication of the main control device may be realized (for example, the bidirectional authentication of the hyper text transfer protocol over secure socket layer in the authentication flow), the security of the data may be improved, or the binding management account information can be realized (for example, the management account information of the target device (for example, the device manufacturer account) in the authentication flow), so that the management party such as the device manufacturer or the like may collect the data such as the user's usage habit in the device, and further improve the product.

In this manner, based on Step S210 to Step S230, when the network configuration is performed based on the main control device, the main control device may execute a user-defined authentication flow through the device configuration information in the network configuration process, so that the management server of the target device authenticates the main control device, and the authentication of the security of the main control device is realized when the network configuration is executed on the target device. Meanwhile, the ecology of the management server and the main control device is reliably associated through the authentication flow. After the target device is bound by the main control device, the management server may obtain the usage data of the target device, and the reliability of the overall network configuration process is effectively improved, thereby improving the user experience.

FIG. 3 schematically illustrates a process diagram of a device network configuration method according to an embodiment of the present disclosure. The execution body of the device network configuration method may be a management server, such as the management server 104 shown in FIG. 1. The execution body of the device network configuration method may be a management server, such as the management server 104 shown in FIG. 1.

As shown in FIG. 3, the device network configuration method may include Steps S310 to S330.

At Step S310, the authentication information uploaded by the main control device is received. At Step 320, the signature information is generated when the authentication of the main control device passes based on the authentication information. At Step 330, the signature information is transmitted by the main control device to the target device, to perform the network configuration processing on the target device by the main control device after the signature information is verified by the target device.

A specific process of performing respective steps in the device network configuration is described below.

At Step S310, the authentication information uploaded by the main control device is received.

The authentication information may include management account information (e.g., device vendor account information) of the target device uploaded by the main control device, a device certificate for performing the bidirectional authentication of the hyper text transfer protocol over secure socket layer with the management server, and the like, and selection information of the data privacy protocol transmitted to the management server.

At Step 320, the signature information is generated when the authentication of the main control device passes based on the authentication information.

The main control device may send the management account information of the target device to the management server by registering or logging in to the management account. The management account information may be the account of the device manufacturer. In this way, the device manufacturer may also authenticate the main control device based on its own account by the management server.

The main control device and the management server to perform the bidirectional authentication by exchanging device certificates according to the hyper text transfer protocol over secure socket layer (HTTPS). Based on this, the management server may authenticate the validity of the identity of the main control device.

In an embodiment, at Step 320, the generating of the signature information includes: generating random signature information as the signature information. The random signature information may be a random number generated by the management server, and the random number is further used as the signature information generated by the authentication flow.

In an embodiment, the authentication information includes management account information of the target device. The generating of the random signature information as the signature information includes: storing the signature information and the management account information associatively. The signature information and the management account information is stored associatively, so that the corresponding signature information is determined by the management account information.

In an embodiment, at Step 320, the generating of the signature information includes: receiving the device configuration information of the target device uploaded by the main control device; and generating the signature information based on the authentication information and the device configuration information.

The device configuration information may include a device vendor identifier (i.e., a unique identifier (VendorId) of the target device of the device vendor), a device model (i.e., a unique identifier (ProductId) of the device model), a device identifier (i.e., a short unique identifier (VendorId) of the device), and a random number generated by the device. The authentication information may include parameters in a process in which the main control device performs the bidirectional authentication of the hyper text transfer protocol over secure socket layer with the management server.

The signature information may be generated based on the authentication information and the device configuration information. The set of the authentication information and the device configuration information may be used as the signature information. Alternatively, the signature information may be generated by performing signature processing on an authentication parameter and the device configuration information based on the target signature algorithm.

The signature information is generated based on the authentication information and the device configuration information, and the authentication flow of the main control device may be effectively verified through validating of the signature information.

In an embodiment, the authentication information includes an authentication parameter used when the main control device performs the bidirectional authentication of the hyper text transfer protocol over secure socket layer with the management server. The generating of the signature information based on the authentication information and the device configuration information includes: performing the signature processing on the authentication parameter and the device configuration information based on the target signature algorithm to generate the signature information. The target signature algorithm may be any algorithm, such as a the MD5 signature algorithm, through which the verification on the reliability of the authentication flow of the main control device can be further improved.

At Step 330, the signature information is transmitted by the main control device to the target device, for the main control device to perform the network configuration processing on the target device after the signature information is verified by the target device.

After the management server generates the signature information, the signature information is transmitted to the main control device. After the main control device obtains the signature information, the signature information is transmitted to the target device. The target device may validate whether the authentication of the main control device by the management server passes based on the signature information.

After the target device validates the signature information, the main control device is allowed to perform the network configuration processing on the target device, so that the authentication of the security of the main control device is realized when the network configuration is executed on the target device. Meanwhile, the ecologies of the main control device and the management server are reliably associated through the authentication flow. The management server may obtain the use data of the device in the later stage. The reliability of the overall network configuration process is effectively improved, and the user experience is improved.

In the above-mentioned embodiments, each embodiment is described with its own emphasis. For parts that are not detailed in detail in a certain embodiment, reference may be made to the above detailed description of the device network configuration method, and details are not described herein again.

In this manner, based on Step S310 to Step S330, when the network configuration is performed based on the main control device, the main control device may execute a user-defined authentication flow through the device configuration information in the network configuration process, so that the management server of the target device authenticates the main control device, and the authentication of the security of the main control device is realized when the network configuration is executed on the target device. Meanwhile, the ecology of the management server and the main control device is reliably associated through the authentication flow. After the target device is bound by the main control device, the management server may obtain the usage data of the target device, and the reliability of the overall network configuration process is effectively improved, thereby improving the user experience.

FIG. 4 schematically illustrates a flow diagram of a device network configuration method according to an embodiment of the present disclosure. The execution body of the device network configuration method may be a management server, such as the management server 104 shown in FIG. 1. The execution body of the device network configuration method may be a target device, such as the target device 102 shown in FIG. 1.

As shown in FIG. 4, the device network configuration method may include Steps S410 to S430.

At Step S410, the device description information including the device configuration information and the flow information is transmitted to the main control device, so that the main control device executes the authentication flow indicated by the flow information according to the device configuration information and obtains the signature information generated by the management server of the target device when the authentication of the main control device by the management server passes. At Step S420, the signature information transmitted by the main control device is received. At Step S430, the signature information is verified, so that the network configuration processing is performed by the main control device on the target device after the signature information is verified.

A specific process of performing respective steps in the device network configuration is described below.

At Step S410, the device description information including the device configuration information and the flow information is transmitted to the main control device, so that the main control device executes the authentication flow indicated by the flow information according to the device configuration information and obtains the signature information generated by the management server of the target device when the authentication of the main control device by the management server passes.

The device description information is information of the target device itself. In this example, the device description information may include at least device configuration information and flow information, and the device configuration information is configuration information of the target device.

The device configuration information may include a device vendor identifier (i.e., a unique identifier (VendorId) of the device vendor) of the target device, a device model (i.e., a unique identifier (ProductId) of the device model), a device identifier (i.e., a short unique identifier (VendorId) of the device), and a random number generated by the device. Here, the short unique identifier of the device is the identifier whose length is less than a predetermined threshold value, may be used to uniquely identify the target device within a small range (for example, within the space in which the device network configuration is executed), but it is not necessary to ensure uniqueness thereof within a large range. The use of the short unique identifier of the device may ensure efficient broadcasting of data in a case where the amount of broadcast data of the target device is limited.

The flow information is used to indicate information of a customized process (for example, an authentication flow) that is determined to be executed by the main control device, and the target device may set an identifier of the customized process (for example, an identifier of 1 indicates that the customized process is to be executed, and an identifier of 0 indicates that the customized process is not be executed).

The target device may transmit the device description information including the device configuration information and the flow information to the main control device in a broadcast manner. After the target device enters the network configuration mode, the method for broadcasting the device description information of the target device may include: Step a, Step b, Step c and Step d. At Step a, the target device as an analog radio access line (SoftAP) broadcasts the device description information through a WiFi protocol. At Step b, the target device as a generic access profile (GAP) peripheral of bluetooth (BLE) performs broadcast device description information. At Step C, the target device enters a local area network (LAN) network (wired to guide the user to enter the WiFi password, etc. or guide the user to enter the WiFi password through the screen of the device, etc.), and performs broadcasting through an in-network multicast or broadcast protocol. At Step d, the target device as a point-to-point device (WiFi P2P device) performs broadcasting through the WiFi protocol.

The authentication flow indicated by the flow information is a process defined by a manager such as a device manufacturer of the target device. The authentication flow is that a process in which the main control device is authenticated by the management server of the target device when the main control device performs the network configuration to the target device.

The main control device performs the authentication flow indicated by the flow information according to the device configuration information. When the authentication of the main control device by the management server of the target device passes, a signature information (which may also be referred to as a device registration token (RegistToken)) is generated, and the signature information is transmitted to the main control device.

At Step S420, the signature information transmitted by the main control device is received.

After obtaining the signature information, the main control device may perform the network configuration processing and transmit the signature information to the target device. For example, the main control device may transmit the network configuration parameters together with the signature information to the target device.

At Step S430, the signature information is verified, so that the network configuration processing is performed by the main control device on the target device after the signature information is verified.

The target device verifies the signature information, that is, validates whether the authentication of the main control device by the management server passes based on the signature information. Then, after the target device validates the signature information, the main control device is allowed to perform network configuration processing on the target device, so that the authentication of the security of the main control device is realized when the network configuration is executed on the target device. Meanwhile, the ecologies of the main control device the management server are reliably associated with through the authentication flow. The management server may obtain the use data of the device in the later stage. The reliability of the overall network configuration process is effectively improved, and the user experience is improved.

After verifying the signature information, the target device may also perform work such as registration of the main control device, and the like. The behaviour when the verification fails is optional, and the network configuration and registration may be completed normally, and the registration may be rejected and an error may be returned. In an embodiment, the network configuration processing is allowed for the main control device to be performed on the target device after the validating of the signature information by the target device passes.

In an embodiment, at Step S430, the verifying of the signature information to perform the network configuration processing on the target device by the main control device after the signature information is verified includes:
obtaining network configuration parameters transmitted by the main control device; and verifying the signature information to perform network configuration processing on the target device based on the network configuration parameters after verifying the signature information.

A network configuration parameter is a parameter used for network configuration, and the network configuration parameter may include a related network configuration parameter used in a network configuration process of device interconnection and interworking. The network configuration parameter may be specific account information or a parameter such as a router name or a password. After the verification of the signature information, transmitted by the main control device, by the target device passes, the target device performs network configuration on the target device by using the network configuration parameter, so that the main control device performs network configuration processing on the target device.

In an embodiment, at Step S430, the verifying of the signature information includes: validating the signature information by a management server.

The target device may transmit the signature information to the management server for comparison and validation by accessing the management server. Further, the management server may perform operations such as binding the target device to the device cloud account of the management server in the process of validating the signature information.

In an embodiment, the signature information is generated based on a target signature algorithm. At step S430, the verifying of the signature information includes: verifying the signature information according to the target signature algorithm.

The signature information is generated based on the target signature algorithm. For example, the management server generates the signature information by signature processing on the device configuration information, other parameters in the device management information, and time stamps, etc. based on the target signature algorithm The target device may locally obtain the configuration parameters for generating the signature information based on the target signature algorithm for validation.

In the above-mentioned embodiments, each embodiment is described with its own emphasis. For parts that are not detailed in detail in a certain embodiment, reference may be made to the above detailed description of the device network configuration method, and details are not described herein again.

In this manner, based on Step S410 to Step S430, when the network configuration is performed based on the main control device, the main control device may execute a user-defined authentication flow through the device configuration information in the network configuration process, so that the management server of the target device authenticates the main control device, and the authentication of the security of the main control device is realized when the network configuration is executed on the target device. Meanwhile, the ecology of the management server and the main control device is reliably associated through the authentication flow. After the target device is bound by the main control device, the management server may obtain the usage data of the target device, and the reliability of the overall network configuration process is effectively improved, thereby improving the user experience.

According to a method described in the above embodiment, examples will be given below in connection with an application scenario for further detailed description. FIG. 5 illustrates a flow of multi-terminal interaction when the device network configuration method according to an embodiment of the present disclosure is applied in the scenario. The meaning of the noun in the scenario is the same as that in the foregoing embodiment. For details, reference may be made to the description in the foregoing embodiment. The process may include the following steps.

The device configuration information is transmitted from the target device to the main control device.

At Step S510, the device description information including the device configuration information and the flow information is transmitted from the target device to the main control device. The device description information transmitted by the target device is received by the main control device.

The target device may transmit the device description information including the device configuration information and the flow information to the main control device in a broadcast manner. After the target device enters the network configuration mode, the method for broadcasting the device description information of the target device may include: Step a, Step b, Step c and Step d. At Step a, the target device as an analog radio access line (SoftAP) broadcasts the device description information through a WiFi protocol. At Step b, the target device as a generic access profile (GAP) peripheral of bluetooth (BLE) performs broadcast device description information. At Step c, the target device enters a local area network (LAN) network (wired to guide the user to enter the WiFi password, etc. or guide the user to enter the WiFi password through the screen of the device, etc.), and performs broadcasting through an in-network multicast or broadcast protocol. At Step d, the target device as a point-to-point device (WiFi P2P device) performs broadcasting through the WiFi protocol.

The device configuration information may include a device vendor identifier (i.e., a unique identifier (VendorId) of the device vendor) of the target device, a device model (i.e., a unique identifier (ProductId) of the device model), a device identifier (i.e., a short unique identifier (VendorId) of the device), and a random number generated by the device. Here, the short unique identifier of the device is the identifier whose length is less than a predetermined threshold value, may be used to uniquely identify the target device within a small range (for example, within the space in which the device network configuration is executed), but it is not necessary to ensure uniqueness thereof within a large range. The use of the short unique identifier of the device may ensure efficient broadcasting of data in a case where the amount of broadcast data of the target device is limited.

The flow information is used to indicate information of a customized process (for example, an authentication flow) that is determined to be executed by the main control device, and the target device may set an identifier of the customized process (for example, an identifier of 1 indicates that the customized process is to be executed, and an identifier of 0 indicates that the customized process is not be executed).

The main control device performs an authentication flow indicated by the flow information according to the device configuration information:

At Step S520, when the flow information includes a predetermined identification, the device management information of the target device is queryed from the common server according to the device configuration information;

At Step S530, an authentication operation corresponding to the device management information is performed, and the authentication information is transmitted to the management server through the authentication operation. The management server receives the authentication information uploaded by the main control equipment.

At Step S540, the management server authenticates the main control device and generates the signature information when the authentication passes, includes:

In an embodiment, the device management information includes a target network address. The step of performing the authentication operation corresponding to the device management information at Step S530 includes: performing the authentication operation according to the target network address so that the management server performs an authenticate operation on the main control device and generates the signature information after the authentication passes, and receiving the signature information returned by the management server.

The performing of the authentication operation according to the target network address so that the management server performs authentication on the main control device and generates the signature information after the authentication passes includes: performing he authentication operation according to the target network address, so as to perform the bidirectional authentication of the hyper text transfer protocol over secure socket layer with the management server, and so as to trigger the management server to authenticate the main control device and to generate the signature information after the authentication passes. In an example, the main control device may perform the bidirectional authentication of the hyper text transfer protocol over secure socket layer with the management server based on the device certificate of the main control device. The validity period of the device certificate is less than the preset threshold value. The device certificate is generated by the ecological server of the main control device. At step S500, the device certificate may be transmitted to the main control device by the ecological server on its own initiative. Alternatively, the device certificate may be transmitted to the main control device after the main control device transmits a request to the ecological server. It should be noted that Step S500 may be performed in any step prior to Step S540, and is not specifically limited herein. Alternatively, the authentication operation is performed according to the target network address so as to transmit management account information of the target device to the management server, and so as to trigger the management server to authenticate the main control device according to the management account information and to generate the signature information when the authentication passes. Alternatively, the authentication operation is performed according to the target network address, so as to transmit selection information of a data privacy protocol to the management server, and so as to so as to trigger the management server to authenticate the main control device according to the selection information and to generate the signature information when the authentication passes.

In an embodiment, the performing of the authentication operation according to the target network address includes: enabling a target application program according to the target network address; performing the authentication operation based on the target application program.

At Step 540, the signature information is generated when the authentication of the configuration server on the main control device passes based on the authentication information.

At Step 540, the generating of the signature information includes: receiving the device configuration information of the target device uploaded by the main control device; and generating the signature information based on the authentication information and the device configuration information. Alternatively, random signature information is generated and used as the signature information.

At Step S560, the signature information is transmitted by the configuration server to the main control device.

At Step S570, the signature information is transmitted by the main control device to the target device. The network configuration parameter is transmitted by the main control device to the target device.

At Step S580, the signature information is verified by the target device, so that the network configuration processing is performed on the target device by the main control device after the signature information is verified. That is, the target device performs network configuration based on the network configuration parameters after verifying the signature information.

At Step 580, the verifying of the signature information includes: validating the signature information by the management server, or verifying the signature information according to the target signature algorithm.

In the above-mentioned embodiments, each embodiment is described with its own emphasis. For parts that are not detailed in detail in a certain embodiment, reference may be made to the above detailed description of the device network configuration method, and details are not described herein again.

To better implement the device network configuration method according to an embodiment of the present disclosure, an embodiment of the present disclosure further provide a device network configuration apparatus based on the device network configuration method described above. The meaning of the nouns is the same as that in the device network configuration method described above. For details, reference may be made to the description in the method embodiment. FIGS. 6, 7, and 8 each illustrates a block diagram of a device networking apparatus according to an embodiment of the present disclosure.

In the block diagram of the device network configuration apparatus according to an embodiment of the present disclosure shown in FIG. 6, the device network configuration apparatus 600 is applied to the main control device, and the device network configuration apparatus 600 may include a device description information receiving module 610, an authentication application module 620, and a network configuration module 630.

The device description information receiving module 610 is configured to receive the device description information transmitted by the target device, where the device description information includes device configuration information and flow information. The authentication application module 620 is configured to perform the authentication flow indicated by the flow information in accordance with the device configuration information, and obtain the signature information generated by the management server of the target device when the authentication of the main control device by the management server of the target device passes. The network configuration module 630 is configured to transmit the signature information to the target device to perform the network configuration processing on the target device after the signature information is validated by the target device.

In some embodiments of the present disclosure, the authentication application module 620 includes a query unit and an execution unit. The query unit is configured to query the device management information of the target device from the common server according to the device configuration information when the flow information includes the predetermined identifier. The execution unit is configured to perform an authentication operation corresponding to the device management information, and obtain the signature information generated by the management server of the target device when the authentication of the management server on the main control device passes.

In some embodiments of the present disclosure, the device management information includes a target network address. The execution unit includes an execution sub-unit and an information receiving subunit. The execution sub-unit is configured to perform the authentication operation according to the target network address so that the management server performs an authenticate operation on the main control device and generates the signature information after the authentication passes. The information receiving subunit is configured to receive the signature information returned by the management server.

In some embodiments of the present disclosure, the execution subunit is configured to perform the authentication operation according to the target network address, so as to perform the bidirectional authentication of the hyper text transfer protocol over secure socket layer with the management server and so as to trigger the management server to authenticate the main control device and to generate the signature information when the authentication passes.

In some embodiments of the present disclosure, the execution subunit is configured to perform the bidirectional authentication of the hyper text transfer protocol over secure socket layer with the management server based on the device certificate of the main control device, where a validity period of the device certificate is less than a preset threshold value, and the device certificate is generated by the ecological server of the main control device.

In some embodiments of the present disclosure, the execution subunit is configured to perform the authentication operation according to the target network address so as to transmit management account information of the target device to the management server, and so as to trigger the management server to authenticate the main control device according to the management account information and to generate the signature information when the authentication passes.

In some embodiments of the present disclosure, the execution subunit is configured to enable the target application program according to the target network address; and perform the authentication operation based on the target application program.

In some embodiments of the present disclosure, the device configuration information includes a device manufacturer identification and a device model of the target device. The query unit is configured to obtain the device manufacturer identification and the device model of the target device and query the device management information uploaded by the device manufacturer of the target device from the common server.

In this manner, based on the device network configuration apparatus 600, when the network configuration is performed based on the main control device, the main control device may execute a user-defined authentication flow through the device configuration information in the network configuration process, so that the management server of the target device authenticates the main control device, and the authentication of the security of the main control device is realized when the network configuration is executed on the target device. Meanwhile, the ecologies of the management server and the main control device are reliably associated through the authentication flow. After the target device is bound by the main control device, the management server may obtain the usage data of the target device, and the reliability of the overall network configuration process is effectively improved, thereby improving the user experience.

In the block diagram of the device network configuration apparatus according to an embodiment of the present disclosure shown in FIG. 7, the device network configuration apparatus 700 is applied to the management server for managing the target device. The device network configuration apparatus 700 may include an authentication information receiving module 710, an authentication response module 720, and a signature information issuing module 730.

The authentication information receiving module 710 may be configured to receive authentication information uploaded by the main control device. The authentication response module 720 may be configured to generate the signature information when the authentication of the main control device passes based on the authentication information. The signature information issuing module 730 may be configured to transmit the signature information to the target device through the main control device so that the network configuration processing is executed by the main control device after the signature information is verified by the target device.

In some embodiments of the present disclosure, the authentication response module 720 includes: a first generating unit configured to generate random signature information as the signature information.

In some embodiments of the present disclosure, the authentication information includes management account information of the target device. After generating the random signature information as the signature information, the apparatus further includes an association unit configured to store the signature information and the management account information associatively.

In some embodiments of the present disclosure, the authentication response module 720 includes: a second generating unit configured to receive the device configuration information of the target device uploaded by the main control device; and generate the signature information based on the authentication information and the device configuration information.

In some embodiments of the present disclosure, the authentication information includes authentication parameters used when the main control device performs the bidirectional authentication of the hyper text transfer protocol over secure socket layer with the management server. The second generating unit configured to perform the signature processing on the authentication parameter and the device configuration information based on the target signature algorithm to generate the signature information.

In this manner, based on the device network configuration apparatus 700, when the network configuration is performed based on the main control device, the main control device may execute a user-defined authentication flow through the device configuration information in the network configuration process, so that the management server of the target device authenticates the main control device, and the authentication of the security of the main control device is realized when the network configuration is executed on the target device. Meanwhile, the ecologies of the management server and the main control device are reliably associated through the authentication flow. After the target device is bound by the main control device, the management server may obtain the usage data of the target device, and the reliability of the overall network configuration process is effectively improved, thereby improving the user experience.

In the block diagram of the device network configuration apparatus according to an embodiment of the present disclosure shown in FIG. 8, the device network configuration apparatus 800 is applied to the target device and the device network configuration apparatus 800 may include a device description information transmitting module 810, a signature information receiving module 820, and a signature information validation module 830.

The device description information transmitting module 810 may be configured to transmit the device description information including the device configuration information and the flow information to the main control device, so that the main control device executes the authentication flow indicated by the flow information according to the device configuration information and obtains the signature information generated by the management server of the target device when the authentication of the management server on the main control device passes. The signature information receiving module 820 may be configured to receive the signature information transmitted by the main control device. The signature information validation module 830 may be configured to verify the signature information, to perform network configuration processing on the target device by the main control device after the signature information is verified.

In some embodiments of the present disclosure, the signature information validation module 830 includes a first verification unit configured to validate the signature information by the management server.

In some embodiments of the present disclosure, the signature information is generated based on a target signature algorithm. The signature information validation module 830 includes a second verification unit configured to verify the signature information according to the target signature algorithm.

In some embodiments of the present disclosure, the signature information validation module 830 is configured to obtain network configuration parameters transmitted by the main control device; and verify the signature information to perform network configuration processing on the target device based on the network configuration parameters after verifying the signature information.

In this manner, based on the device network configuration apparatus 800, when the network configuration is performed based on the main control device, the main control device may execute a user-defined authentication flow through the device configuration information in the network configuration process, so that the management server of the target device authenticates the main control device, and the authentication of the security of the main control device is realized when the network configuration is executed on the target device. Meanwhile, the ecologies of the management server and the main control device are reliably associated through the authentication flow. After the target device is bound by the main control device, the management server may obtain the usage data of the target device, and the reliability of the overall network configuration process is effectively improved, thereby improving the user experience.

It should be noted that although several modules or units of the device for operation execution are mentioned in the above detailed description, such division is not mandatory. Indeed, according to embodiments of the present disclosure, the features and functions of two or more modules or units described above may be embodied in one module or unit. Conversely, the features and functions of one of the modules or units described above may be further divided into a plurality of modules or units to be embodied.

An embodiment of the present disclosure further provides an electronic device, as shown in FIG. 9, showing a schematic block view of an electronic device according to an embodiment of the present disclosure.

The electronic device may include components such as a processor 901 of one or more processing cores, a memory 902 of one or more computer-readable storage media, a power supply 903, an input unit 904, or the like. It will be appreciated by those skilled in the art that the electronic device shown in FIG. 9 does not limit the electronic device in the present disclosure, and the electronic device may include more or less components than illustrated, or may combine certain components, or different component arrangements.

The processor 901 is a control center of the electronic device, is connected to various parts of the entire electronic device by various interfaces and lines, and performs various functions and processes data of the electronic device by running or executing software programs and/or modules stored in the memory 902, and invoking data stored in the memory 902. Alternatively, the processor 901 may include one or more processing cores. In an embodiment, the processor 901 may be integrated with an application processor and a modem processor. The application processor generally processes an operating system, an object interface, an application program, or the like. The modem processor generally processes wireless communication. It will be appreciated that the above modem processor may also not be integrated into the processor 901.

The memory 902 may be configured to store software programs and modules. The processor 901 executes various functional applications and data processing by running the software programs and modules stored in the memory 902. The memory 902 may generally include a storage program area and a storage data area. The storage program area may store an operating system, an application program (such as a sound play function, an image play function, or the like) required by at least one function, and the like. The storage data area may store data, or the like created according to use of the computer device. In addition, the memory 902 may include high speed random access memory, and may also include non-volatile memory, such as at least one magnetic disk storage device, flash memory device, or other volatile solid state storage device. Accordingly, the memory 902 may further include a memory controller to provide access to the memory 902 by processor 901.

The electronic device further includes a power supply 903 for supplying power to the respective components. For example, the power supply 903 may be logically connected to the processor 901 through a power management system, so that functions such as charging, discharging, or power consumption management are managed through the power management system. The power supply 903 may further include one or more DC or AC power supplies, a recharging system, a power failure detection circuit, a power converter or inverter, a power status indicator, or any other component.

The computer device may further include an input unit 904, and the input unit 904 is configured to receive input numeric or character information and to generate a signal input of keyboard, mouse, joystick, or optical ball or trackball in relation to object settings and functional control.

Although not shown, the electronic device may further include a display unit or the like, and details are not described herein. In an embodiment, the processor 901 in the electronic device loads executable files corresponding to the processes of one or more application programs into the memory 902, according to the following steps, and the computer programs stored in the memory 902 are executed by the processor 901, thereby implementing various functions.

When the electronic device is the main control device, the processor 901 may be configured to receive the device description information transmitted by the target device, where the device description information includes device configuration information and flow information; perform the authentication flow indicated by the flow information in accordance with the device configuration information; obtain the signature information when the authentication of the management server of the target device on the main control device passes; and transmit the signature information to the target device, to perform the network configuration processing on the target device after the signature information is validated by the target device.

When the electronic device is the management server, the processor 901 may be configured to receive authentication information uploaded by the main control device; generate the signature information when the authentication of the main control device passes based on the authentication information; and transmit the signature information to the target device through the main control device so that the network configuration processing is executed by the main control device after the signature information is verified by the target device.

When the electronic device is the target device, the processor 901 may be configured to: transmit the device description information including the device configuration information and the flow information to the main control device, so that the main control device 101 executes the authentication flow indicated by the flow information according to the device configuration information and obtains the signature information generated by the management server 104 when the authentication of the management server 104 of the target device on the main control device passes; receive the signature information transmitted by the main control device; and verifying the signature information, so that the main control device 101 performs network configuration processing on the target device after the signature information is verified.

It will be appreciated by those of ordinary skill in the art that all or a portion of the steps of one of the various methods according to the above-described embodiments may be executed by a computer program, which may be stored in a computer-readable storage medium and loaded and executed by the processor, or by relevant hardware controlled by the computer program.

To this end, the present disclosure provides a storage medium having stored thereon a plurality of computer programs that can be loaded by the processor, to perform the steps in any of the methods according to embodiments of the present disclosure.

The storage medium may include a read-only memory (ROM), a random access memory (RAM), a magnetic disk, an optical disk, or the like.

Since the computer program stored in the storage medium may perform the steps in any of the methods according to and of the embodiments of the present disclosure, the advantageous effects achieved in any of the methods according to embodiments of the present disclosure may be realized. For details, refer to the foregoing embodiments, and details are not described herein.

Other embodiments of the present disclosure will readily occur to those skilled in the art upon consideration of the specification and practice of the embodiments disclosed herein. The present disclosure is intended to cover any variations, applications or adaptive changes of the present disclosure that follow the general principles of the present disclosure and include common knowledge or customary technical means in the art not disclosed herein.

The present disclosure is not limited to the specific structures described above and illustrated in the accompanying drawings, and various modifications and changes may be made without departing from the scope thereof.

1. A device network configuration method applied to a main control device and comprising:
receiving device description information transmitted by a target device, and the device description information comprises device configuration information and flow information;
performing an authentication flow indicated by the flow information based on the device configuration information and obtaining signature information generated by a management server of the target device in response that authentication of the main control device by the management server passes; and
transmitting the signature information to the target device to perform network configuration processing on the target device after the signature information is validated by the target device.

2. The device network configuration method of claim 1, wherein the performing of the authentication flow indicated by the flow information based on the device configuration information and the obtaining of the signature information generated by the management server of the target device in response that the authentication of the main control device by the management server passes comprises:
querying device management information of the target device from a common server based on the device configuration information; and
performing an authentication operation corresponding to the device management information and obtaining the signature information generated by the management server of the target device in response that the authentication of the main control device by the management server passes.

3. The device network configuration method of claim 2, wherein the device management information comprises a target network address, and
the performing of the authentication operation corresponding to the device management information and the obtaining of the signature information generated by the management server of the target device in response that the authentication of the main control device by the management server passes comprises:
performing the authentication operation based on the target network address so that the management server performs an authenticate operation on the main control device and generates the signature information in response that the authentication passes; and
receiving the signature information returned by the management server.

4. The device network configuration method of claim 3, wherein the performing of the authentication operation based on the target network address so that the management server performs the authenticate operation on the main control device and generates the signature information in response that the authentication passes comprises:
performing the authentication operation based on the target network address, so as to perform bidirectional authentication of a hyper text transfer protocol over secure socket layer with the management server and so as to trigger the management server to authenticate the main control device and to generate the signature information in response that the authentication passes.

5. The device network configuration method of claim 4, wherein the performing of the bidirectional authentication of the hyper text transfer protocol over secure socket layer with the management server comprises:
performing the bidirectional authentication of the hyper text transfer protocol over secure socket layer with the management server based on a device certificate of the main control device, wherein a validity period of the device certificate is less than a preset threshold value, and the device certificate is generated by an ecological server of the main control device.

6. The device network configuration method of claim 3, wherein the performing of the authentication operation based on the target network address so that the management server performs an authenticate operation on the main control device and generates the signature information in response that the authentication passes comprises:
performing the authentication operation based on the target network address, so as to transmit management account information of the target device to the management server, and so as to trigger the management server to authenticate the main control device based on the management account information and to generate the signature information in response that the authentication passes.

7. The device network configuration method of claim 3, wherein the performing of the authentication operation based on the target network address comprises:
enabling a target application program based on the target network address; and
performing the authentication operation based on the target application program.

8. The device network configuration method of claim 2, wherein the device configuration information comprises a device manufacturer identification and a device model of the target device,
the querying of the device management information of the target device from the common server based on the device configuration information comprises:
querying the device management information uploaded by a device manufacturer of the target device from the common server based on the device manufacturer identification and the device model of the target device.

9. A device network configuration method applied to a management server for managing a target device and comprising:
receiving authentication information uploaded by a main control device;
generating signature information in response that authentication of the main control device passes based on the authentication information; and
transmitting the signature information to the target device through the main control device to perform network configuration processing on the target device by the main control device after the signature information is verified by the target device.

10. The device network configuration method of claim 9, wherein the generating of the signature information comprises:
generating random signature information as the signature information.

11. The device network configuration method of claim 10, wherein the authentication information comprises management account information of the target device;
the generating of the random signature information as the signature information comprises:
storing the signature information and the management account information associatively.

12. The device network configuration method of claim 9, wherein the generating of the signature information comprises:
receiving device configuration information of the target device uploaded by the main control device; and
generating the signature information based on the authentication information and the device configuration information.

13. The device network configuration method of claim 12, wherein the authentication information comprises an authentication parameter used when the main control device performs bidirectional authentication of a hyper text transfer protocol over secure socket layer with the management server;
the generating of the signature information based on the authentication information and the device configuration information comprises:
performing signature processing on the authentication parameter and the device configuration information based on a target signature algorithm to generate the signature information.

14. A device network configuration method applied to a target device and comprising:
transmitting device description information comprising device configuration information and flow information to a main control device, so that the main control device performs an authentication flow indicated by the flow information based on the device configuration information and obtains signature information generated by a management server of the target device in response that authentication of the main control device by the management server passes;
receiving the signature information transmitted by the main control device; and
verifying the signature information so that network configuration processing is performed on the target device by the main control device after the signature information is verified.

15. The device network configuration method of claim 14, wherein the verifying of the signature information comprises:
validating the signature information through the management server.

16. The device network configuration method of claim 14, wherein the signature information is generated based on a target signature algorithm, and the verifying of the signature information comprises:
verifying the signature information based on the target signature algorithm.

17. The device network configuration method of claim 14, wherein the verifying of the signature information so that the network configuration processing is performed on the target device by the main control device after the signature information is verified comprises:
obtaining a network configuration parameter transmitted by the main control device; and
verifying the signature information, to perform the network configuration processing on the target device based on the network configuration parameter after verifying the signature information.

18-20. (canceled)

21. A computer-readable storage medium having stored thereon a computer program which, when executed by a processor of a computer, configured for the computer to perform operations of the method of claim 1.

22. An electronic device comprises a memory storing a computer program; a processor for reading a computer program stored in the memory to perform operations of the method of claim 1.
